(19) United States
(12) Patent Application Publication
(10) Pub. No.: US 2008/0149503 A1
(43) Pub. Date: Jun. 26, 2008

(54) Device and Method For Crimping A Tube

(76) Inventor: Michael Pandori, Oak Ridge, NJ (US)

Correspondence Address: GORE ENTERPRISE HOLDINGS, INC., 551 PAPER MILL ROAD, P. O. BOX 9206, NEWARK, DE, 19714-9206, US

(21) Appl. No.: 11/613,653

(22) Filed: Dec. 20, 2006

(51) Int. Cl. B23D 21/10; F16L 55/10; B21D 31/00; B21D 35/00

(52) U.S. Cl. 206/223; 72/325; 72/412; 72/409.19; 72/372

(57) ABSTRACT

A device for contamination-free sealing of a tube having a collar positioned thereon. The device can include a first jaw portion and a second jaw portion. The first jaw portion can include two pressing bars extending outwardly therefrom, and a pressing piece extending outwardly therefrom. The pressing piece can include a substantially flat surface, and can be positioned between the pressing bars. The pressing bars each have a pressing surface. The second jaw portion can include a support surface. Each of the pressing surfaces can be substantially flat. When the first jaw portion is moved toward the second jaw portion, each of the two pressing bars contacts the collar proximate an end portion of the collar, and the pressing piece contacts the collar proximate a center portion of the collar.

### FIELD OF THE INVENTION

The present invention relates generally to systems having tubes, and, more particularly, to devices and methods for crimping and separating tubes.

### BACKGROUND OF THE INVENTION

In the pharmaceutical, chemical, and other fields that use tubing in the processing and transport of fluids, there is often a need for crimping and cutting portions of the tubing, to seal off and isolate the fluids within from contamination from the external environment. In one method, a cylindrical metal collar or sleeve is placed over a portion of the tube, and the collar and tube are deformed and cut, thus forming a crimped end, as is known in the art. To this end, various types of devices have been created to achieve this type of crimping.

In certain circumstances, however, present crimping devices have certain deficiencies. For example, the crimps formed by present crimping devices tend to be relatively prone to loosening, or coming off of the silicone tubing, with normal usage or moderate pulling. Further, present crimping devices for use with tubing that use a cutting edge to separate the sleeve are subject to wear and tear on the cutting edge that can result in dulling or breaking of the cutting blade, depending on the hardness of the material used for the collar or sleeve. Such wear and tear can result in a shortened useful life for the crimping and cutting jaws. In particular, use of stainless steel sleeves is advantageous in pharmaceutical applications for reasons well known in the art, but stainless steel is a particularly hard material that requires great force to cut, often requiring the use of a heat-treated or otherwise hardened (such as by applying a hardening plating or coating) cutting edge, which can also increase the cost of the tool. Cutting edges also pose a potential hazard to the user. In addition, with present crimping devices, it is often difficult to consistently position tubes and collars within the crimping device for consistent crimping and/or cutting.

Thus, there is a need for an improved device and method for crimping and separating tubes.

### SUMMARY OF THE INVENTION

Embodiments of the present invention satisfy these and other needs by providing an improved device and method for crimping and separating tubes.

Embodiments can include a device for contamination-free sealing of a tube having a collar positioned thereon. The device can include a first jaw portion and a second jaw portion. The first jaw portion can include two pressing bars extending outwardly therefrom, and a pressing piece extending outwardly therefrom. The pressing piece can include a substantially flat surface, and can be positioned between the pressing bars. The pressing bars each have a pressing surface. The second jaw portion can include a support surface. Each of the pressing surfaces can be substantially flat. When the first jaw portion is moved toward the second jaw portion, each of the two pressing bars contacts the collar proximate an end portion of the collar, and the pressing piece contacts the collar proximate a center portion of the collar.

In some embodiments, the second jaw portion can comprise first and second stabilizer recesses, each of the stabilizer recesses being located adjacent a respective folding pocket, and being designed and dimensioned to receive a respective first and second end of the collar. The stabilizer recesses facilitate positioning of the collar for crimping.

In some embodiments, at least one of the folding arms, when inserted at least partially into one of the folding pockets, can form at least one indentation in the collar. Each of the folding arms and each of the folding pockets can impart a radial compression in both a longitudinal direction and a latitudinal direction on the collar.

Thus, embodiments of the invention provide for a crimping tool that facilitates efficient and advantageous crimping and separating tubes and collars.

### BRIEF DESCRIPTION OF THE DRAWINGS

The device and method will be more readily understood from the detailed description of exemplary embodiments presented below, considered in conjunction with the attached drawings, of which:

FIG. 1 is a side elevational view of an embodiment of a crimping device;

FIG. 2 is a perspective view of an embodiment of a crimping device with a section of tubing and a crimp collar positioned therein;

FIG. 3 is a front cross-sectional view of an embodiment of crimping jaws, in an open position, with a portion of tubing and a crimping collar positioned therein;

FIG. 4 is a front cross-sectional view of an embodiment of crimping jaws, in a closed position, with a portion of tubing and a crimping collar positioned therein;

FIG. 5 is a top plan view of an embodiment of a portion of tubing and a crimping collar after being crimped;

FIG. 6 is a side elevational view of an embodiment of a portion of tubing and a crimping collar after being crimped;

FIGS. 7a and 7b are perspective views of an embodiment of first and second jaw portions of a crimping device;

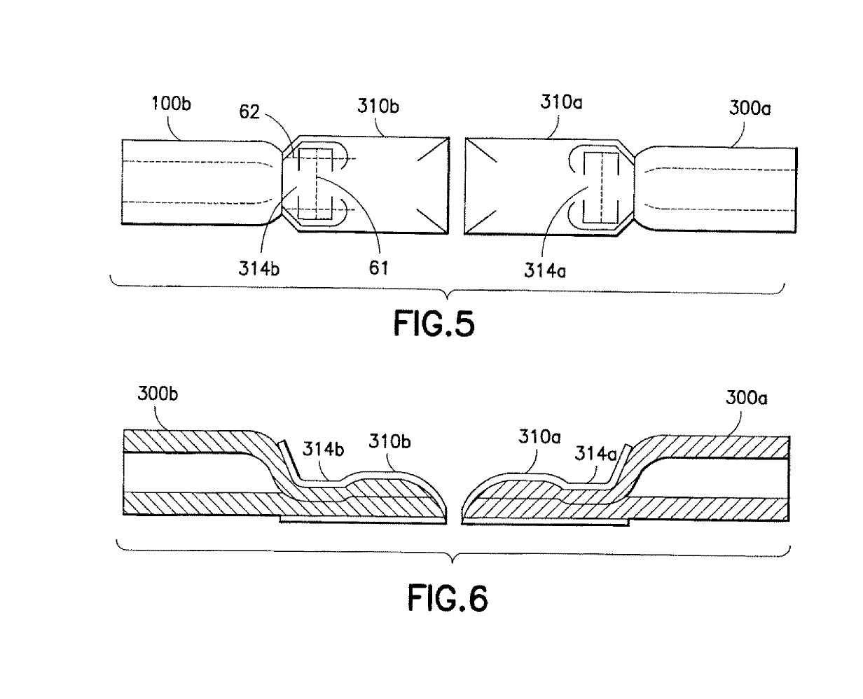

FIGS. 5a and 5b are perspective views of an embodiment of first and second jaw portions of a crimping device;

FIGS. 9a and 9b are perspective views of an embodiment of a second jaw portion with a crimp collar positioned thereon;

FIGS. 10a and 10b are perspective views showing features of another embodiment of a crimping device;

FIGS. 11a-11e show features of another embodiment of a crimp collar in accordance with an embodiment of the invention;

FIG. 12 is a perspective view showing features of another embodiment of a crimping device;

FIG. 13 is a perspective view showing features of the embodiment shown in FIG. 12, and also showing an alignment portion; and

FIGS. 14a and 14b are perspective views showing features of another embodiment of a crimping device.

It is to be understood that the attached drawings are for purposes of illustrating the concepts of the invention and may not be to scale.

### DETAILED DESCRIPTION OF THE INVENTION

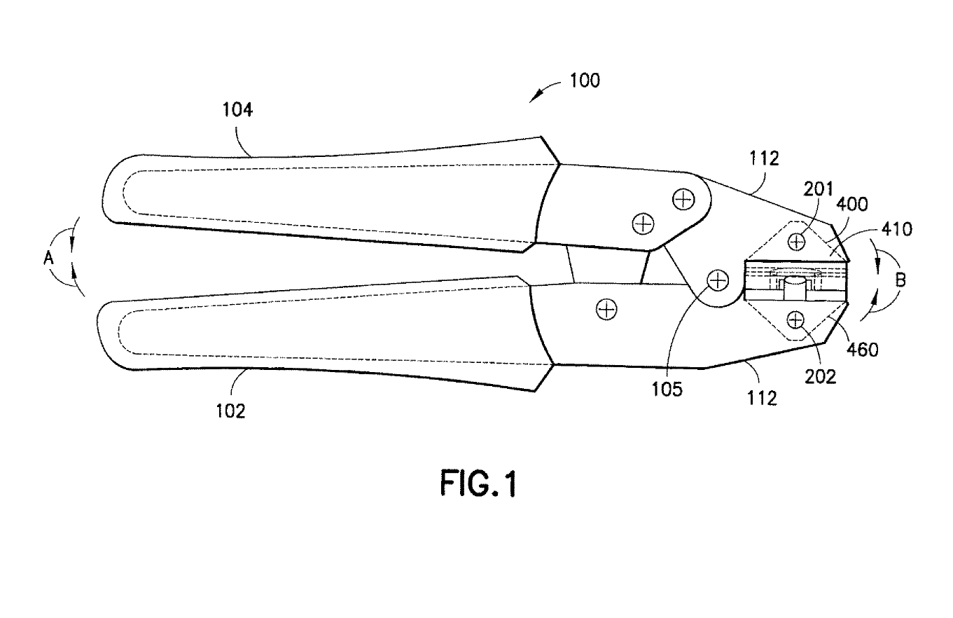

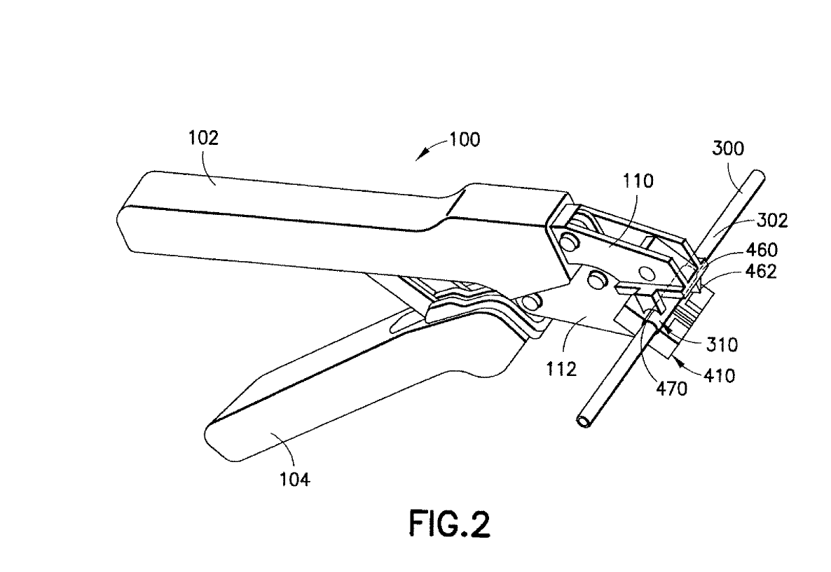

With reference to FIGS. 1 and 2, there is shown an embodiment of a crimping device 100. The device 100 includes first and second handles 102, 104, which may be opened and closed (direction A), and generally pivoted about hinge portion 105, to open and close corresponding jaw holders 110, 112, along an arcuate path (direction B), as is known to those skilled in the art.

Jaw portions 400 include a first jaw portion 460, and a second jaw portion 410, each of which may be positioned within one of jaw holders 110, 112. In some embodiments, fasteners 201, 202 can be used to secure first and second jaw portions 460, 460 to jaw holders 110, 112, respectively. Fasteners 201, 202 can be a screw or other fastening device, as would be known to one of skill in the art, as instructed by the present disclosure.

A collar 310 can be positioned on a silicone or other appropriate tube 300, as is known to those skilled in the art. The tube 300 and collar 310 can be positioned between the first and second jaw portions 460, 410, and, when the first and second handles 102, 104 are brought together, and moved toward one another, the first and second jaw portions 460, 410 move toward each other to crimp and cut the tube 300 and collar 310, as is described in further detail below.

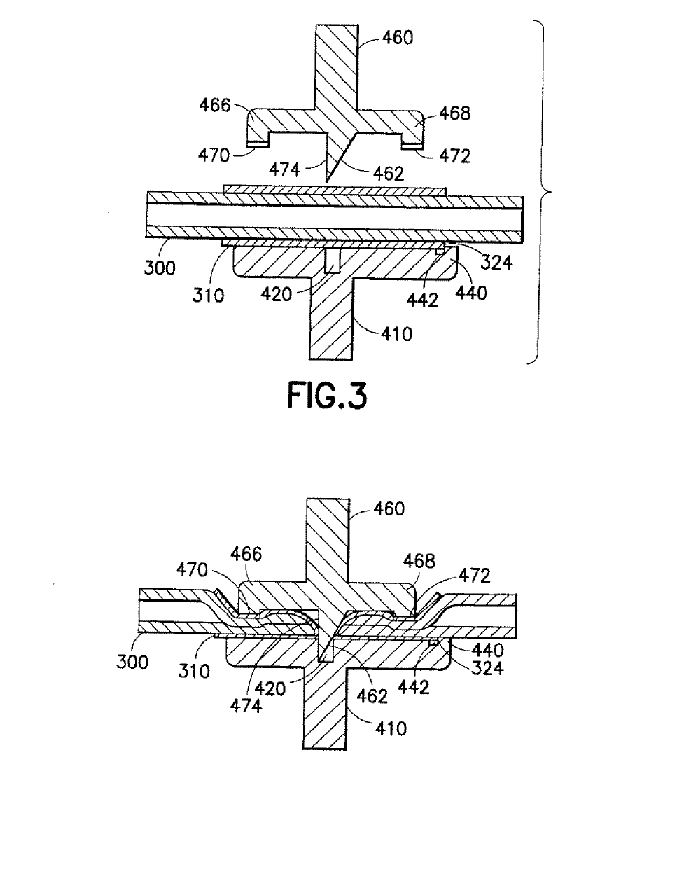

With reference to FIGS. 3 and 4, there is shown the first and second jaw portions 460, 410, in greater detail. In some embodiments, first and second jaw portions 460, 410 can be formed of hardened steel. In other embodiments, first and second jaw portions 460, 410 can be formed of other materials, as would be known to one skilled in the art, as informed by the present disclosure. First jaw portion 460 can include a cutter portion 462 extending outward therefrom. Cutter portion 462 can include a sharp edge and can be designed and dimensioned to cut the wall of tube 300 and collar 310. Folding arms 466, 468 extend outwardly from first jaw portion 460, in a direction substantially parallel to that of cutter portion 462. Each of folding arms 466, 468 includes a pressing surface 470, 472 at a distal end thereof. In some embodiments, pressing surfaces 470, 472 can be curved. In other embodiments, pressing surfaces 470, 472 can have other shapes.

Second jaw portion 410 includes a cutter recess 420 defined therein. Cutter recess 420 is designed and dimensioned to receive a portion of cutter portion 462 when the first jaw portion 460 and second jaw portion 410 are moved toward one another. Second jaw portion 410 also has first and second folding pockets 426, 428 defined therein. The first and second folding pockets 426, 428 are designed and dimensioned to receive corresponding folding arms 466, 468 when the first jaw portion 460 and second jaw portion 410 are moved toward one another.

In some embodiments, second jaw portion 410 can include support portions 414, 416, that extend outward from second jaw portion 410. Support portions 414, 416 are positioned adjacent to, and outside of respective first and second folding pockets 426, 428. In some embodiments, each of inner surfaces 422, 424 extend adjacent to and between cutter recess 420 and a respective one of the first and second folding pockets 426, 428. An alignment portion 440, having and abutment surface 442, can be used to facilitate positioning of collar 310 in a fixed position, while allowing the tube 300 to pass through the collar 310, and past alignment portion 440, as is described in further detail below.

In some embodiments, cutter portion 462 can be selectively removably coupled or connected to first jaw portion 460. Cutter portion 462 can be coupled to first jaw portion 460 by a tongue in groove connection, set screw, and/or other known fastening methods, as would be known to those of skill in the art, as informed by the present disclosure.

In some embodiments, second jaw portion 410 can include cutter portion 462, and first jaw portion 460 can include cutter recess 420.

In some embodiments, second jaw portion 410 can include alignment portion 440, with first jaw portion 410 not including folding arms 466, 468.

With reference to FIGS. 5 and 6, there is shown the resultant tube portions 300a, 300b and collar portions 310a, 310b after crimping with crimping device 100.

In use, by way of crimping with an embodiment of the present invention, the cutter portion 462 moves toward and within cutter recess 420, advantageously forming a complete cut and separation of the tube portions 300a, 300b and corresponding collar portions 310a, 310b, without need for further bending or fracturing by a user. Also, due to the pivoting closing motion of jaw holders 110, 112 and corresponding jaw portions 460, 410, when the first jaw portion 460 and the second jaw portion 410 are moved together, the cutter portion 462 approaches the cutter recess 420 in an arcuate path. In this manner, the collar 310 and tube 300 are gradually cut as the cutter portion 462 progressively contacts the collar 310 and tube 300.

In addition, in some embodiments, indented portions 314a, 314b can be formed on the collar portions 310a, 310b and tube portions 300a, 300b, such that the collar portions 310a, 310b are relatively firmly secured to respective tube portions 300a, 300b, by way of the movement of the folding arms 466, 468 toward respective folding pockets 426, 428. In addition, with specific reference to FIG. 5, in some embodiments, by way of the movement of the folding arms 466, 468, the collar portions 310a, 310b and corresponding tube portions 300a, 300b are compressed along both latitudinal L2 and longitudinal L1 axes, advantageously forming a relatively secure crimp connection between the collar portions 310a, 310b and corresponding tube portions 300a, 300b. In other embodiments, tube portions 300a, 300b and collar portions 310a, 310b can be compressed in other manners.

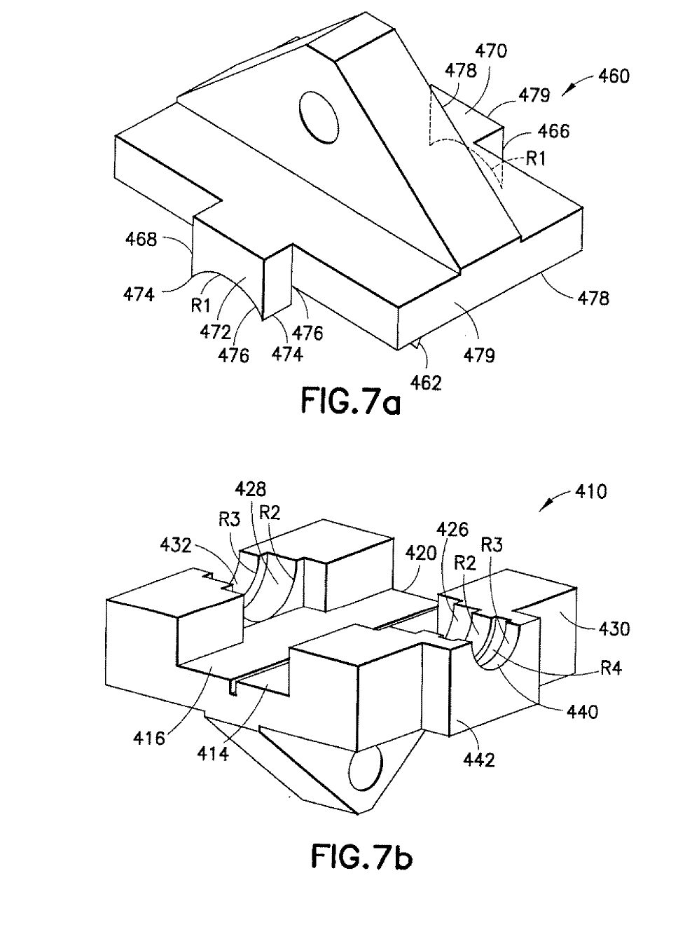

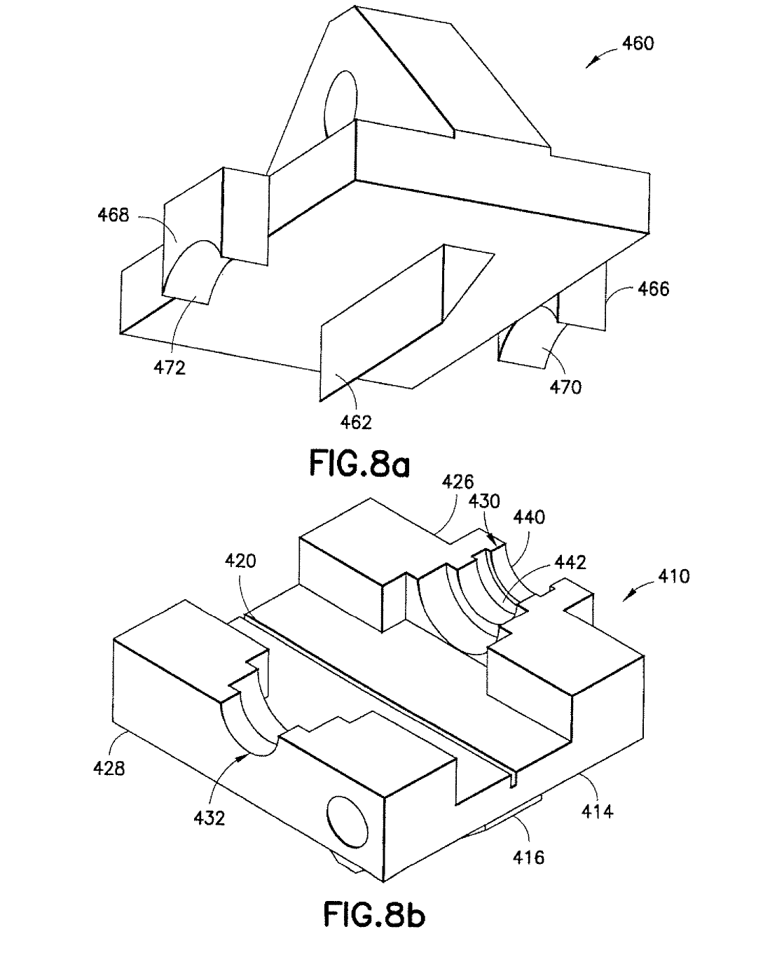

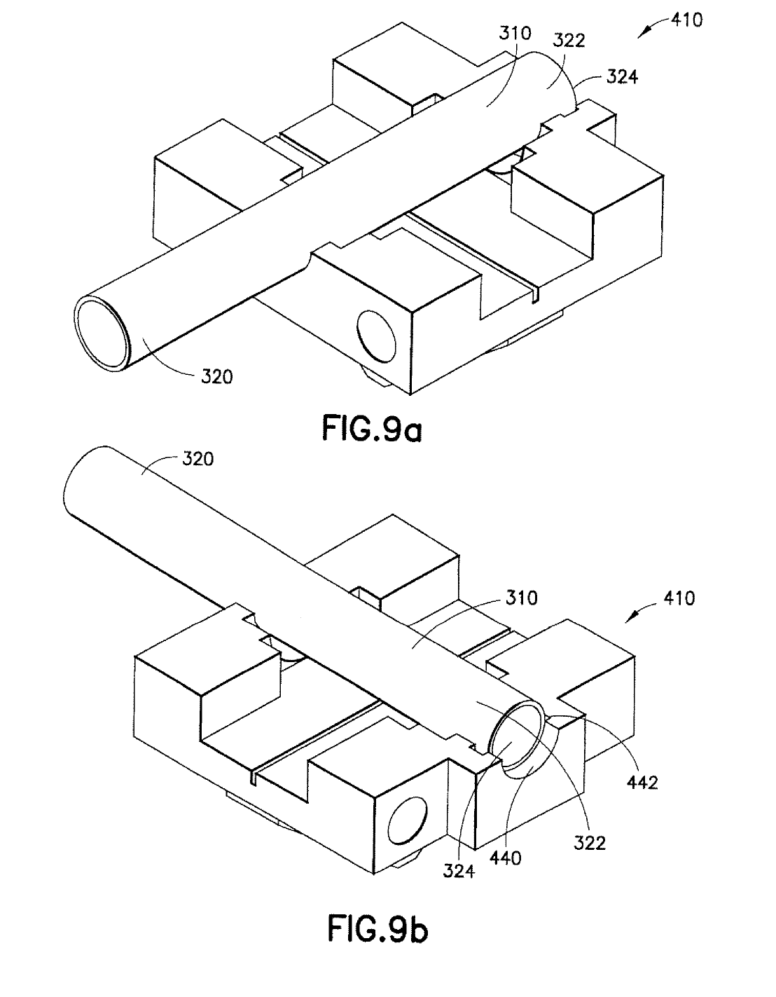

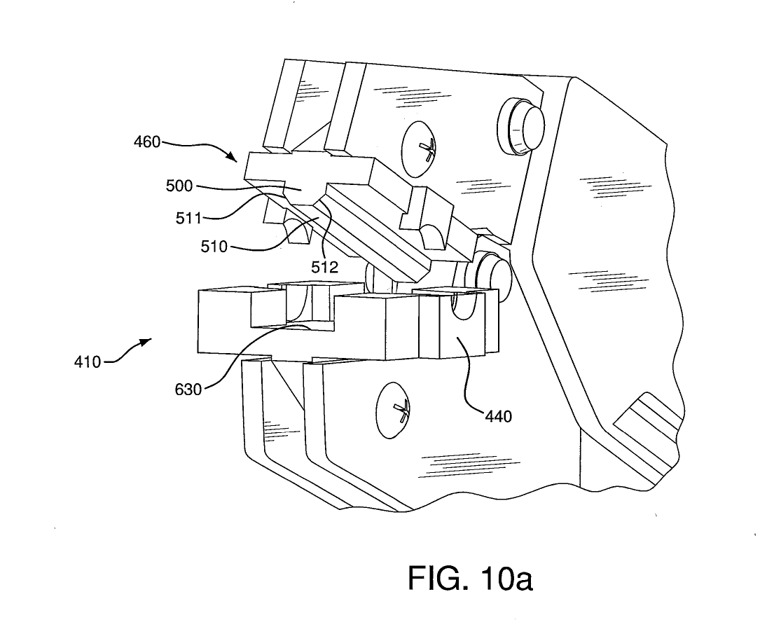

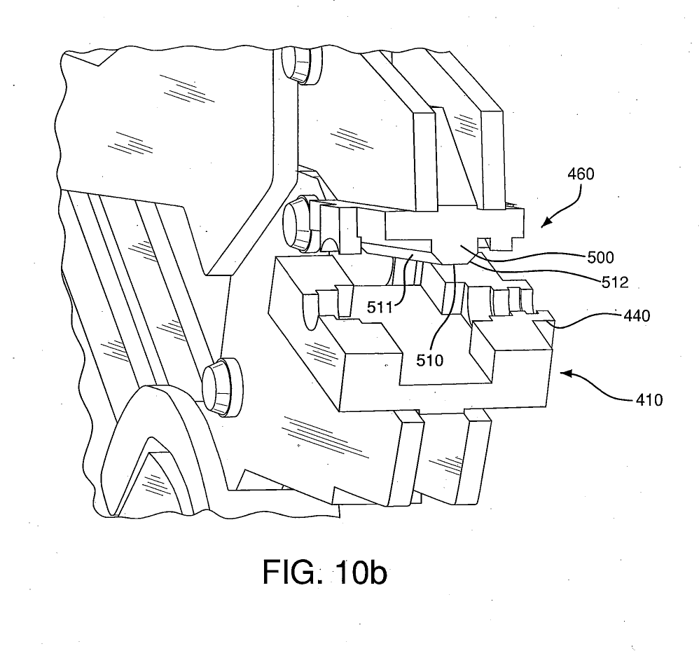

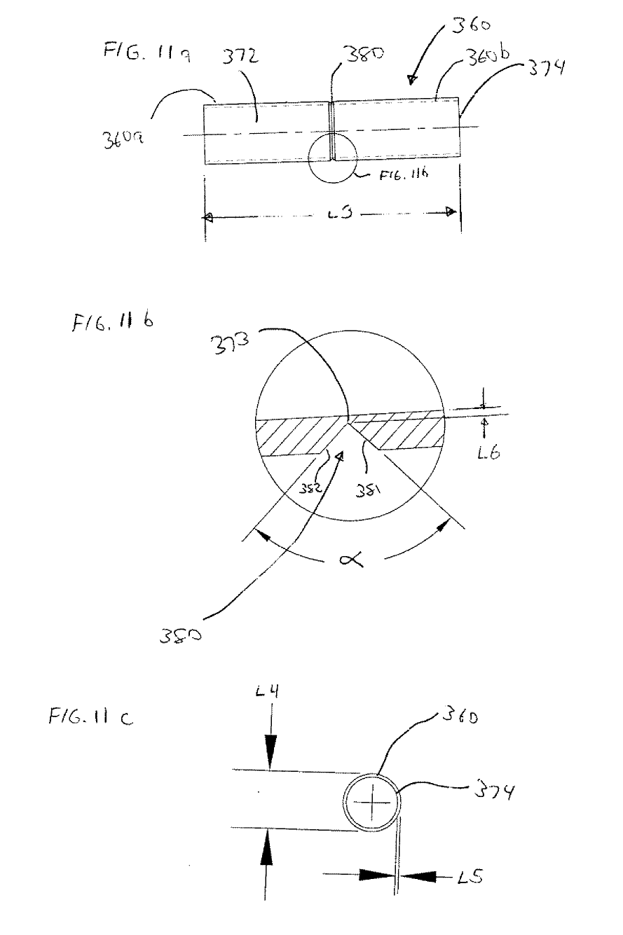

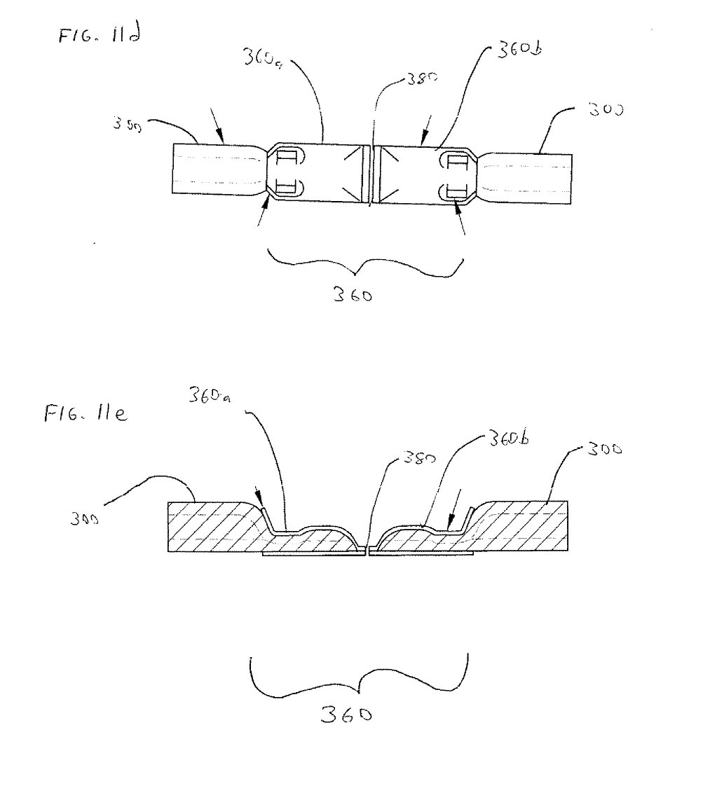

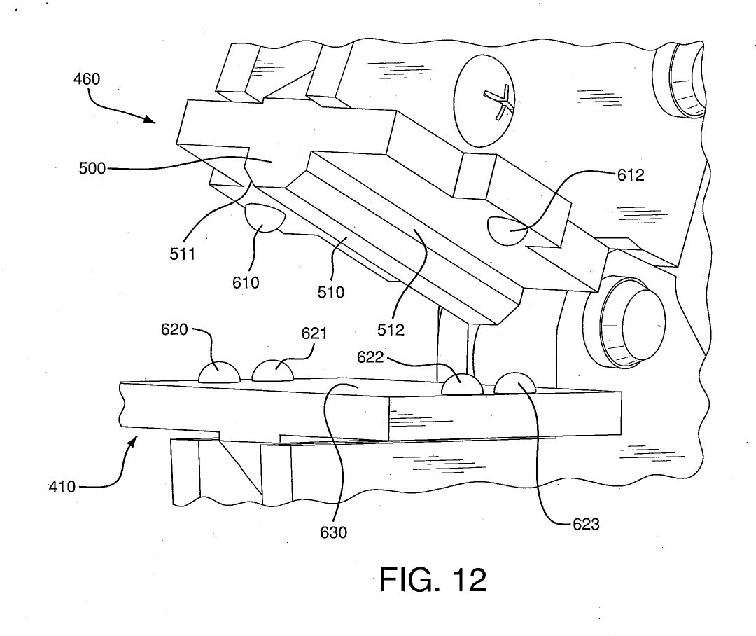

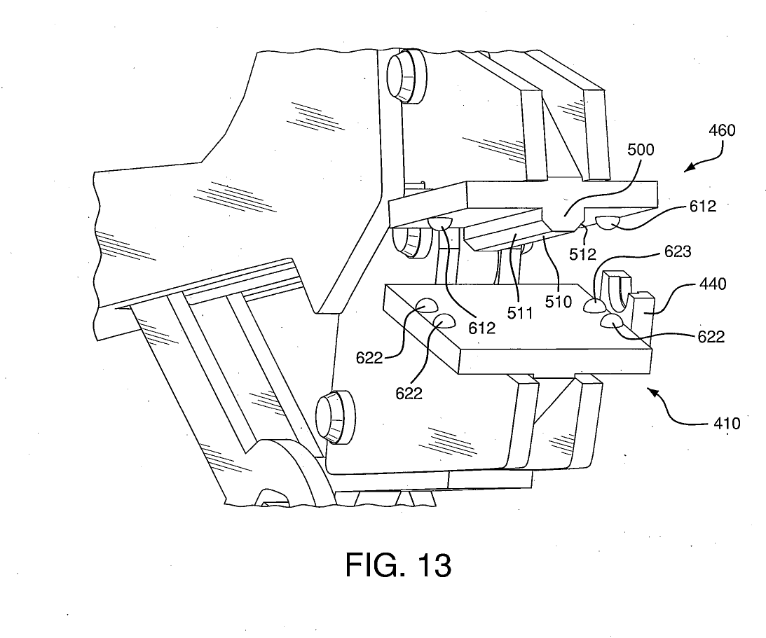

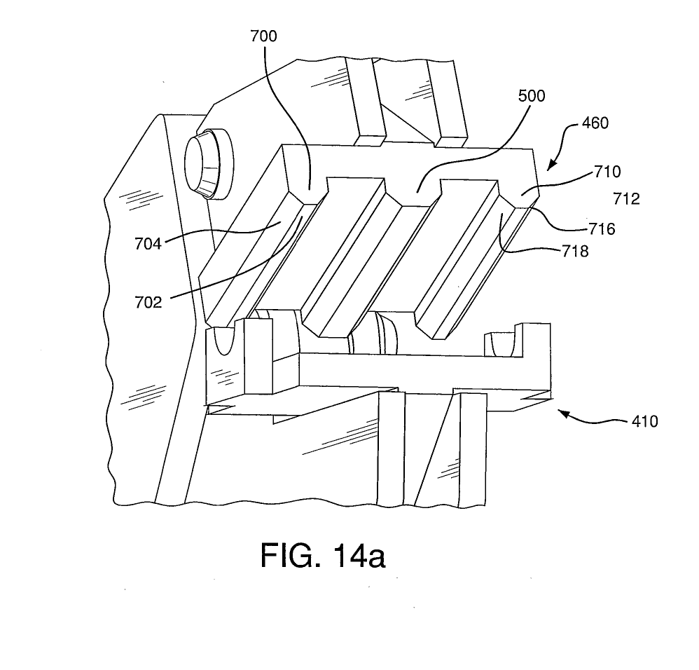

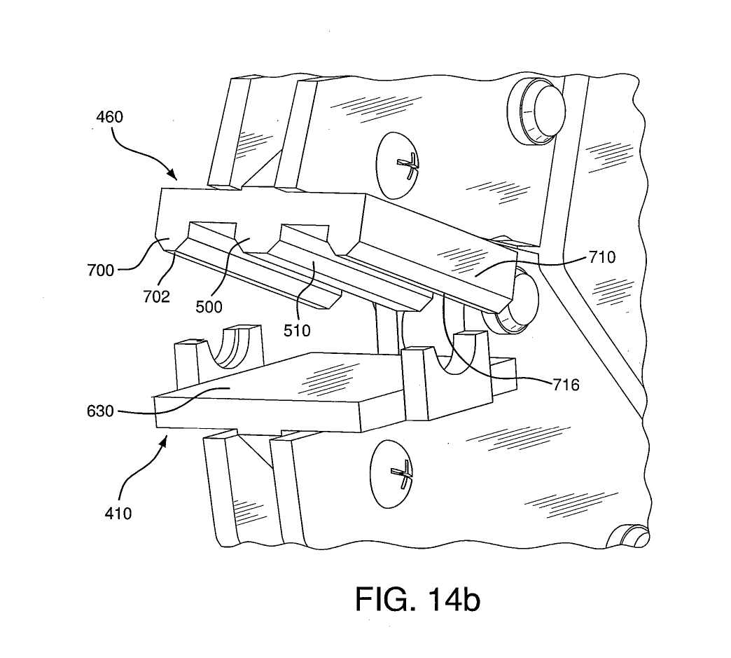

With reference to FIGS. 7a, 7b, 8a and 8b, first jaw portion 460 and a second jaw portion 410 are shown in further detail. First jaw portion 460 includes a cutter portion 462 extending outward therefrom. Each of folding arms 466, 468 can include a pressing surface 470, 472 at a distal end thereof. In some embodiments curved pressing surfaces 470, 472 have a curved shape, and each has a radius R1 in the range of 0.2 to 0.5 inches, and preferably 0.3 inches. In other embodiments, different radius dimensions and surface shapes can be employed.

As described above, second jaw portion 410 includes a cutter recess 420 defined therein. The first and second folding pockets 426, 428 are designed and dimensioned to receive corresponding folding arms 466, 468 when the first jaw portion 460 and second jaw portion 410 are moved together. In some embodiments folding pockets 426, 428 can have a radius R2 in the range of 0.2 to 0.8 inches, preferably 0.2 inches. In other embodiments, different radius dimensions and pocket shapes can be employed.

Second jaw portion 410 can also include first and second stabilizer recesses 430, 432, located adjacent folding pockets 426, 428. First and second stabilizer recesses 430, 432 facilitate the positioning and stabilizing of a collar 310, and tube 300 within, during the crimping and cutting process. In some embodiments first and second stabilizer recesses 430, 432 can have a radius R3 in the range of 0.1 to 0.5 inches, and preferably 0.1 inches. In other embodiments, different radius dimensions can be employed.

With additional reference to FIGS. 9a and 9b, second jaw portion 410 can also include the alignment portion 440, including an abutment surface 442. An end 324 of collar 310 can be placed in contact with abutment surface 442 such that collar 310 is beneficially positioned to receive cutter portion 462 at a predetermined distance from the end of the collar (for clarity, tube 300 is not shown in FIGS. 9a and 9b). In some embodiments, alignment portion 440 and abutment surface 442 are designed and dimensioned such that cutter portion 462 contacts a center portion of collar 310. In some embodiments, alignment portion 440, can be used to facilitate positioning of collar 310 in a fixed position, while allowing the tube 300 to pass through the collar 310, and past alignment portion 440. Thus, in some embodiments, alignment portion 440 can facilitate the retention of the collar 310 in place, while allowing movement of tube 300 through the collar. In some embodiments alignment portion 440 can have an alignment surface 444 having a radius R4 in the range of 0.1 to 0.6 inches, and preferably 0.1 inches. In other embodiments, different radius dimensions can be employed.

Thus, a device and method for crimping tubing has been shown and described that can be used in conjunction with non-reinforced silicone tubing and is not limited to use with reinforced tubing or hose. By way of embodiments of the invention, a device has been described whereby a relatively higher crimping force is created in comparison to existing devices that require greater user effort. Such generation of a greater and concentrated crimping force allows embodiments of the invention to be used in conjunction with a collar made from stainless steel, and is not limited to use with collars formed from relatively “softer” materials such as nickel or chrome plated brass.

A device in accordance with embodiments of the invention includes a small, lightweight, ergonomic design that is relatively easy for a user to wield in confined and low-access spaces. In embodiments of the invention, the jaws can be formed in a single-piece construction for durability. Such embodiments have certain benefits as compared to some prior art designs that include bolt-on adapters which can be easily broken or result in lost pieces when, for example, screws fall out and parts get lost during use or during installation.

Embodiments of the invention make use of a relatively simple scissor-like action for crimping, as opposed to a relatively more complex cam design employed by prior art devices. In addition, in certain embodiments of the invention, the jaws of the device can be easily replaced by removal of a fastener 201, 202 (see FIG. 1) for each of the respective jaw portions 410, 460.

In embodiments of the invention, in use, a second, or lower jaw engages a first, or upper jaw in a radial arcuate path. Such engagement on an angle creates a gradual compression, starting from one side of the crimp collar and traversing across the crimp collar and tube perpendicularly. Such angular engagement requires less force to be applied by the user than with prior art devices wherein crimping engagement is not performed at an angle.

With reference to FIGS. 10a and 10b, there are shown perspective views illustrating another embodiment of the invention. First jaw portion 460 includes pressing piece 500 extending outwardly therefrom. Pressing piece 500 can include flat surface 510, and angled surfaces 511, 512. Flat surface 510 can have a shape that is substantially flat. Pressing piece 500 is designed and dimensioned such that, when the first jaw portion 460 and second jaw portion 410 are moved together, flat surface 510 contacts a crimp collar, such as collar 360, described in further detail below. First jaw portion 460 can include support surface 630, which can be substantially parallel to flat surface 510 at a position wherein flat surface 510 and support surface 630 are both in contact with collar 360 (or collar 310). As described above with respect to other embodiments, by way of the movement of the folding arms 466, 468, the end portions of the collar and corresponding tube portions can be compressed, advantageously forming a relatively secure crimp connection between the collar end portions and corresponding tube portions. In other embodiments, as described in further detail below, first jaw portion 460 can be formed without folding arms 466, 468. In such embodiments, first jaw portion 460 can include straight pressing bars 700, 710 (see FIGS. 14a and 14b), for forming crimp connections, as is described in further detail below.

With reference to FIGS. 11a-11e, and with continued reference to FIGS. 10a and 10b, another embodiment of a crimp collar 360 is similar in many respects to crimp collar 310 discussed above. Thus, tube 300 (see FIG. 2) and collar 360 can be positioned between the first and second jaw portions 460, 410, and, when the first and second handles 102, 104 are brought together, and moved toward one another, the first and second jaw portions 460, 410 move toward each other to crimp the tube 300 and collar 360, as is described in further detail below.

Collar 360 has end 374, and wall 372 having a circumferential recess 380 defined therein, which creates a region 373 having a reduced wall thickness. In some embodiments, collar 360 can have a length L3 in the range of 1.0 to 1.50 inches, preferably 1.25 inches. In some embodiments, wall 372 can have a thickness L5 in the range of 0.010 to 0.020 inches, preferably 0.007 inches, and collar 360 can have an outer diameter L4 in the range of between 7/32 and 11/32 of an inch, preferably 9/32 of an inch. Reduced wall thickness region 373 can preferably have a thickness L6 that is less than one-half of wall thickness L5, and more preferably in the range of one-fourth to one-tenth the thickness of wall thickness L5. With reference to FIG. 11b, circumferential recess 380 can be defined, in part, by walls 381, 382. Wall 381 can be oriented with respect to wall 382 at an angle α d which can be in the range of 75 degrees to 105 degrees, preferably 90 degrees. Other lengths and angles can be used, as would be known to one of skill in the art, as informed by the present disclosure.

In use, the first and second jaw portions 460, 410 move toward each other, to crimp the tube 300 and collar 360, such that flat surface 510 contacts wall 372, and compresses collar 360 and tube 300 within. Support surface 630 contacts wall 372 of collar 360 at a position substantially opposite from flat surface 510, and can provide a surface against which flat surface 510 can compress collar 360. Collar 360 can be designed and dimensioned such that alignment portion 440 and abutment surface 442 facilitate positioning of collar 360, as described above with respect to other embodiments. Flat surface 510 can contact collar 360 and circumferential recess 380 such that flat surface 510 contacts collar 360 in a region overlying circumferential recess 380.

In some embodiments, particularly where collar 360 is formed of a relatively brittle metal such as stainless steel, as flat surface 510 compresses collar 360 and tube 300 within, stresses induced in reduced wall thickness region 373 of collar 360 cause collar 360 to fracture or separate into two portions 360a and 360b (see FIGS. 11d and 11e). After the collar has been fractured into two portions 360a and 360b, further compression causes the walls 381 and 382 to collapse onto, and the fractured walls 381 and 382 to bear down on, tube 300, partially or fully severing tube 300.

In some embodiments, after collar 360 and tube 300 are compressed, collar 360 can be bent about circumferential recess 380 such that collar 360 can be easily separated into two distinct pieces. Tube 300 can be separated into two respective pieces as well, as the compression of collar 360 and tube 300 by flat surface 110 can cause walls 381, 382 of circumferential recess 380 to be deformed and partially or fully sever tube 300. In embodiments where tube 300 is not severed during the crimping process, tube 300 can be cut with a cutting tool to separate it into two portions.

Where collar 310 (which does not include circumferential recess 380) is used, crimped and compressed collar 310 can have a flattened region where flat surface 510 has compressed collar 310. Crimped collar 310 can subsequently be separated by cutting along the flattened region with a cutting tool.

With reference to FIG. 12, another embodiment of a crimping device can comprise a first jaw portion 460 including first protrusion 610 and second protrusion 612 extending outwardly therefrom, in the same direction as pressing piece 500. First protrusion 610 and second protrusion 612 can be positioned at opposite sides of pressing piece 500. First and second protrusions 610 and 612, can be hemispheroidal in shape. A benefit of the use of hemispheroidal or substantially hemispheroidal protrusions is that they can impart a smooth and graduated compression force on a collar 360 (or collar 310).

Second jaw portion 410 can include third protrusions 620, 621 and fourth protrusions 622, 623 extending outwardly therefrom. Third protrusions 620, 621 and fourth protrusions 622, 623 can be hemispheroidal in shape. Third protrusions 620, 621 can be adjacently positioned, and fourth protrusions 622, 623 can be adjacently positioned, such that, when first jaw portion 460 is moved toward second jaw portion 410, first protrusion 610 moves to a position proximate third protrusions 620, 621, and second protrusion 612 moves to a position proximate fourth protrusions 622, 623.

Thus, as first jaw portion 460 is moved toward second jaw portion 410, protrusions 610, 620, 621, can cooperate to compress one end of collar 360 (or collar 310) and protrusions 612, 622, 622, can cooperate to compress the other end of collar 360 (or collar 310).

With reference to FIG. 13, embodiments of the crimping device as described with respect to FIG. 12 can have a second jaw portion 410 including an alignment portion 440. Alignment portion 440 can facilitate the positioning of collar 360 (or collar 310) as described above with respect to other embodiments.

In some embodiments, second jaw portion 410 can include folding pockets 426, 428 (not shown) as described above with respect to other embodiments (see, e.g., FIG. 7b). In such embodiments, protrusions 612 can move to a position proximate the folding pockets, to crimp and compress portions of collar 360 (or collar 310) as described above with respect to other embodiments. Alternatively, two hemispheroidal protrusions may be used in place of each protrusion 612.

In some embodiments, instead of pressing piece 500, first jaw portion 460 can include a cutter portion 462 (not shown), as described above with respect to other embodiments (see e.g., FIG. 5a). In this embodiment, protrusions 612 extend outwardly from first jaw portion 460, in the same direction as cutter portion 462. Protrusions 612 can be positioned at opposite sides of cutter portion 462.

With reference to FIGS. 14a and 14b, there are shown perspective views showing another embodiment of the invention. First jaw portion 460 includes pressing piece 500 extending outwardly therefrom, as described above with respect to other embodiments. In this embodiment, first jaw portion 460 also includes straight pressing bars 700, 710 extending outwardly therefrom, in the same direction as pressing piece 500. Straight pressing bar 700 can include a flat surface 702, and angled surfaces 704, 706. Similarly, straight pressing bar 710 can include a flat surface 712, and angled surfaces 714, 716. Pressing bars 700, 710 do not need to be straight, bar-shaped or include flat surfaces, but can be any shape or configuration of protruding surface that would sufficiently crimp collar 360 or 310 to seal tube 300.

Straight pressing bars 700, 710 are designed and dimensioned such that, when the first jaw portion 460 and second jaw portion 410 are moved together, pressing surfaces 702, 712 each contact a crimp collar, such as collar 360, as described above, such that the end portions of the collar 360 (or collar 310) and corresponding tube portions can be compressed, advantageously forming a relatively secure crimp connection between the collar 360 end portions and corresponding tube portions.

It is to be understood that the exemplary embodiments are merely illustrative of the invention and that many variations of the above-described embodiments can be devised by one skilled in the art without departing from the scope of the invention. It is therefore intended that all such variations be included within the scope of the following claims and their equivalents.

What is claimed is:

1. A device for contamination-free sealing of a tube having a collar positioned thereon, the device comprising:
a first jaw portion, comprising two pressing bars extending outwardly therefrom, and a pressing piece extending outwardly therefrom, the pressing piece comprising a substantially flat surface, and being positioned between the pressing bars, the pressing bars each having pressing surface; and
a second jaw portion, comprising a support surface.

2. The device of claim 1, wherein each of the pressing surfaces is substantially flat.

3. The device of claim 1, wherein, when the first jaw portion is moved toward the second jaw portion, each of the two pressing bars, and the pressing piece, contact a wall of the collar.

4. The device of claim 1, wherein, when the first jaw portion is moved toward the second jaw portion, each of the two pressing bars contacts the collar proximate an end portion of the collar, and the pressing piece contacts the collar proximate a center portion of the collar.

5. A device for contamination-free sealing of a tube having a collar positioned thereon, the device comprising:
a first jaw portion, comprising two pressing portions extending outwardly therefrom, and a pressing piece extending outwardly therefrom, the pressing piece comprising a substantially flat surface, and being positioned between the pressing portions; and
a second jaw portion, comprising a support surface;
wherein, when the collar is positioned between the first and second jaw portions, and the first jaw portion is moved toward the second jaw portion, the two pressing portions and the pressing piece each compresses the collar against the support surface in a separate location.

6. The device of claim 5, wherein the second jaw portion comprises two folding pockets, each folding pocket being designed and dimensioned to receive a respective one of the two pressing portions.

7. A method of crimping and separating a collar positioned on a tube, the collar comprising a circumferential recess, the method comprising:
positioning a portion of the collar and a portion of the tube between the jaws of a crimping device; and
compressing, with the crimping device, the collar at three locations on the collar;
wherein one of the locations is proximate the circumferential recess, and compressing the collar at that location causes the collar to separate into two portions.

8. A sampling system for sampling a liquid in a sterile environment, the system comprising:
one or more process vessels for distributing the liquid;
one or more tubes connected to the process vessels, for sampling the liquid;
a collar, for positioning over the tube, the collar comprising a circumferential recess;
a crimping tool, the tool comprising;
a first handle and a second handle, the first and second handles being connected about a hinge portion;
a first jaw holder, coupled to the first handle, and a second jaw holder coupled to the second handle;
a first jaw portion, coupled to the first jaw holder, the first jaw portion comprising two pressing bars extending outwardly therefrom, and a pressing piece extending outwardly therefrom, the pressing piece comprising a substantially flat surface, and being positioned between the pressing bars, the pressing bars each having a pressing surface; and
a second jaw portion, coupled to the second jaw holder, the second jaw portion comprising a support surface;
wherein, when the first jaw portion and the second jaw portion are moved together, the flat surface of the pressing piece contacts the collar and compresses the collar against the support surface, causing the collar to separate at the circumferential recess, and each pressing bar compresses a portion of the collar distal the circumferential recess.

9. A kit for contamination-free sealing of a tube in a sterile environment, the kit comprising:
a kit container, the kit container comprising:
a collar, for positioning over the tube, the collar comprising a circumferential recess; and
a crimping tool, the tool comprising: a first handle and a second handle, the first and second handles being connected about a hinge portion; a first jaw holder coupled to the first handle, and a second jaw holder coupled to the second handle; a first jaw portion, coupled to the first jaw holder, the first jaw portion comprising two pressing bars extending outwardly therefrom, and a pressing piece extending outwardly therefrom, the pressing piece comprising a substantially flat surface, and being positioned between the pressing bars, the pressing bars each having a pressing surface; and a second jaw portion, coupled to the second jaw holder, the second jaw portion comprising a support surface; wherein, when the first jaw portion and the second jaw portion are moved together, the flat surface of the pressing piece contacts the collar and compresses the collar against the support surface, causing the collar to separate at the circumferential recess, and each pressing bar compresses a portion of the collar distal the circumferential recess.

10. A method for crimping a collar positioned on a tube, the method comprising the steps of:
providing a tube;
providing a collar having a circumferential recess defined therein;
positioning the collar over the tube;
providing a crimping tool, the tool comprising;
a first handle and a second handle, the first and second handles being connected about a hinge portion;
a first jaw holder, coupled to the first handle, and a second jaw holder coupled to the second handle;
a first jaw portion, coupled to the first jaw holder, the first jaw portion comprising two pressing bars extending outwardly therefrom, and a pressing piece extending outwardly therefrom, the pressing piece comprising a substantially flat surface, and being positioned between the pressing bars;
a second jaw portion, coupled to the second jaw holder, the second jaw portion comprising a support surface; and
moving the first jaw portion and the second jaw portion together, such that each of the pressing bars compresses a portion of the collar distil the recess, and the pressing piece compresses the collar against the support surface at a location proximate the circumferential recess, causing the collar to separate at the circumferential recess.

11. A method for crimping a tube, the method comprising the steps of:
providing a tube;
providing a collar;
positioning the collar over the tube;
providing a crimping tool, the tool comprising;
a first handle and a second handle, the first and second handles being connected about a hinge portion;
a first jaw holder, coupled to the first handle, and a second jaw holder coupled to the second handle;
a first jaw portion, coupled to the first jaw holder, the first jaw portion comprising two pressing bars extending outwardly therefrom, and a pressing piece extending outwardly therefrom, the pressing piece comprising a substantially flat surface, and being positioned between the pressing bars;
a second jaw portion, coupled to the second jaw holder, the second jaw portion comprising a support surface;
moving the first jaw portion and the second jaw portion together, such that each of the pressing bars compresses proximate an end portion of the collar, and the pressing piece compresses the collar against the support surface at a location proximate the center of the collar; and
cutting the portion of the collar compressed by the pressing; piece with a cutting tool.

12. A device for crimping a tube having a collar positioned thereon, the device comprising:
a first jaw portion, comprising two folding arms extending outwardly therefrom, and a pressing piece extending outwardly therefrom, the pressing piece comprising a substantially flat surface, and being positioned between the folding arms, the folding arms each having a pressing surface; and
a second jaw portion, comprising a support surface, and two folding pockets, each folding pocket being designed and dimensioned to receive a respective one of the two folding arms.

13. The device of claim 12, the second jaw portion comprising first and second stabilizer recesses defined therein, each of the stabilizer recesses being located adjacent a respective folding pocket, and being designed and dimensioned to receive a respective first and second end of the collar, wherein the stabilizer recesses facilitate positioning of the collar for crimping.

14. The device of claim 12, wherein at least one of the folding arms, when inserted at least partially into one of the folding pockets, forms at least one indentation in the collar.

15. The device of claim 14, wherein each of the pressing surfaces are curved.

16. The device of claim 12, wherein the pressing piece and support surface are designed and dimensioned such that the tube and collar are compressed when the first jaw portion and the second jaw portion are moved together.

17. The device of claim 12, wherein, when the first jaw portion and the second jaw portion are moved together, the pressing piece contacts the collar and compresses the collar against the support surface.

18. The device of claim 13, the second jaw portion comprising an alignment portion adjacent one of the stabilizer recesses, wherein the alignment portion facilitates the positioning of the collar such that the pressing portion contacts the collar at a predetermined distance from an edge of the collar.

19. The device of claim 18, the alignment portion comprising an abutment surface, the abutment surface facilitating the positioning of the collar when an edge of the collar is positioned in contact with the abutment surface.

20. A device for crimping a tube having a collar positioned thereon, the device comprising:
a first jaw portion, comprising two folding arms extending outwardly therefrom, and a pressing piece extending outwardly therefrom, the pressing piece comprising a substantially flat surface, and being positioned between the folding arms, the folding arms each having a pressing surface; and
a second jaw portion, comprising a support surface, and two folding pockets, each folding pocket being designed and dimensioned to receive a respective one of the two folding arms;
the second jaw portion comprising first and second stabilizer recesses, each of the stabilizer recesses being located adjacent a respective folding pocket, and being designed and dimensioned to receive a respective first and second end of the collar, wherein the stabilizer recesses facilitate positioning of the collar for crimping;
wherein, when the first jaw portion and the second jaw portion are moved toward one another, the flat surface of the pressing piece approaches the support surface in an arcuate path.

21. A device for crimping a tube having a collar positioned thereon, the device comprising:
a first jaw portion, comprising two folding arms extending outwardly therefrom, and a pressing piece extending outwardly therefrom, the pressing piece comprising a substantially flat surface, and being positioned between the folding arms, the folding arms each having a pressing surface; and
a second jaw portion, comprising a support surface, and two folding pockets, each folding pocket being designed and dimensioned to receive a respective one of the two folding arms;
the second jaw portion comprising an alignment portion adjacent one of the stabilizing portions, wherein the alignment portion facilitates the positioning of the collar such that pressing piece contacts the collar at a predetermined distance from an edge of the collar; and
the second jaw portion comprising first and second stabilizer recesses defined therein, each of the stabilizer recesses being located adjacent a respective folding pocket, and being designed and dimensioned to receive a respective first and second end of the collar, wherein the stabilizer recesses facilitate positioning of the collar for crimping.

22. A device for crimping a tube having a collar positioned thereon, the device comprising:
a first handle and a second handle, the first and second handles being connected about a hinge portion;
a first jaw holder, coupled to the first handle, and a second jaw holder coupled to the second handle;
a first jaw portion, coupled to the first jaw holder, the first jaw portion comprising two folding arms extending outwardly therefrom, and a pressing piece extending outwardly therefrom, the pressing piece comprising a substantially flat surface, and being positioned between the folding arms, the folding arms each having a pressing surface; and
a second jaw portion, coupled to the second jaw holder, the second jaw portion comprising a support surface, each folding pocket being designed and dimensioned to receive a respective one of the two folding arms.

23. The device of claim 22, the second jaw portion comprising first and second stabilizer recesses, each of the stabilizer recesses being located adjacent a respective folding pocket, and being designed and dimensioned to receive a respective first and second end of the collar, wherein the stabilizer recesses facilitate positioning of the collar for crimping.

24. The device of claim 22, wherein at least one of the folding arms, when inserted at least partially into one of the folding pockets, forms at least one indentation in the collar.

25. The device of claim 24, wherein each of the pressing surfaces is curved.

26. The device of claim 22, wherein the pressing piece and the support surface are designed and dimensioned such that the tube and collar are compressed when the first jaw portion and the second jaw portion are moved together.

27. The device of claim 22, wherein, when the first jaw portion and the second jaw portion are moved together, the pressing piece approaches the support surface in an arcuate path.

28. The device of claim 22, the second jaw portion comprising an alignment portion adjacent one of the stabilizing portions, wherein the alignment portion facilitates the positioning of the collar such that the pressing piece contacts the collar at a predetermined distance from an edge of the collar.

29. The device of claim 28, the alignment portion comprising an abutment surface, the abutment surface facilitating the positioning of the collar when an edge of the collar is positioned in contact with the abutment surface.

30. A device for crimping a tube having a collar positioned thereon, the device comprising:
a first jaw portion, comprising two folding arms extending outwardly therefrom, and a pressing piece extending outwardly therefrom, the pressing piece comprising a substantially flat surface, the folding arms each having a pressing surface; and
a second jaw portion, comprising the cutter portion extending outwardly therefrom, and two folding pockets, each folding pocket being designed and dimensioned to receive a respective one of the two folding arms.

31. The device of claim 30, the second jaw portion comprising first and second stabilizer recesses defined therein, each of the stabilizer recesses being located adjacent a respective folding pocket, and being designed and dimensioned to receive a respective first and second end of the collar, wherein the stabilizer recesses facilitate positioning of the collar for crimping.

32. The device of claim 30, wherein at least one of the folding arms, when inserted at least partially into one of the folding pockets, forms at least one indentation in the collar.

33. A device for use with a tube having a collar positioned thereon, the device comprising:
a first jaw portion, comprising a pressing piece extending outwardly therefrom, the pressing piece comprising a substantially flat surface; and
a second jaw portion comprising support surface, the second jaw portion comprising first and second stabilizer recesses defined therein, the stabilizer recesses being designed and dimensioned to receive a respective first and second end of the collar, wherein the stabilizer recesses facilitate positioning of the collar for crimping, and an alignment portion adjacent one of the stabilizer portions, wherein the alignment portion facilitates the positioning of the collar such that the pressing piece contacts the collar at a predetermined distance from an edge of the collar.

34. The device of claim 33, the alignment portion comprising an abutment surface, the abutment surface facilitating the positioning of the collar when an edge of the collar is positioned in contact with the abutment surface.

35. A system for crimping a tube having a collar positioned thereon, the system comprising:
a tube;
a collar, for positioning over the tube;
a crimping tool, the tool comprising;
a first handle and a second handle, the first and second handles being connected about a hinge portion;
a first jaw holder, coupled to the first handle, and a second jaw holder coupled to the second handle;
a first jaw portion, coupled to the first jaw holder, the first jaw portion comprising two folding arms extending outwardly therefrom, and a pressing piece extending outwardly therefrom, the pressing piece comprising a substantially flat surface, the folding arms each having a pressing surface; and
a second jaw portion, coupled to the second jaw holder, the second jaw portion comprising a support surface, and two folding pockets, each folding pocket being designed and dimensioned to receive a respective one of the two folding arms.

36. A device for crimping a tube having a collar positioned thereon, the device comprising:
a first jaw portion, comprising a pressing piece extending outwardly therefrom, the pressing piece comprising a substantially flat surface; and
a second jaw portion comprising a support surface, the second jaw portion comprising an alignment portion, wherein the alignment portion facilitates the positioning of the collar such that pressing piece contacts the collar at a predetermined distance from an edge of the collar.

37. A method for crimping a tube having a collar positioned thereon, the method comprising
positioning the tube having a collar positioned thereon between a first jaw portion, the first jaw portion comprising two folding arms extending outwardly therefrom, and a pressing piece extending outwardly therefrom, the pressing piece comprising a substantially flat surface, and being positioned between the folding arms, the folding arms each having a curved pressing surface, and a second jaw portion, comprising a recess, the recess being designed and dimensioned to receive the cutter portion, and two folding pockets, each folding pocket being designed and dimensioned to receive a respective one of the two folding arms; and
moving the first jaw portion toward the second jaw portion such that at least one of the folding arms, when moved toward one of the folding pockets, crimps the tube and the collar.

38. The method of claim 37, the second jaw portion comprising first and second stabilizer recesses, each of the stabilizer recesses being located adjacent a respective folding pocket, and being designed and dimensioned to receive a respective first and second end of the collar, wherein the stabilizer recesses facilitate positioning of the collar for crimping.

39. The method of claim 37, comprising forming at least one indentation in the collar by moving at least one of the folding arms toward one of the folding pockets.

40. The method of claim 39, comprising compressing the collar against the support surface with the pressing piece.

41. The method of claim 37, comprising positioning the collar in contact with an alignment portion such that the pressing piece contacts the collar at a predetermined distance from an edge of the collar.

42. The method of claim 41, comprising positioning an edge of the collar in contact with an abutment surface of the alignment portion.

43. A device for crimping a tube having a collar positioned thereon, the collar having a circumferential recess defined therein, the device comprising:
a first jaw portion, comprising two folding arms extending outwardly therefrom, and a pressing piece extending outwardly therefrom, the pressing piece comprising a substantially flat surface, and being positioned between the folding arms, the folding arms each having a pressing surface; and
a second jaw portion, comprising a support surface, and two folding pockets, each folding pocket being designed and dimensioned to receive a respective one of the two folding arms;
wherein, when the first jaw portion and the second jaw portion are moved together, the flat surface of the pressing piece contacts the collar and compresses the collar against the support surface, causing the collar to separate at the circumferential recess.

44. The device of claim 43, the second jaw portion comprising first and second stabilizer recesses defined therein, each of the stabilizer recesses being located adjacent a respective folding pocket, and being designed and dimensioned to receive a respective first and second end of the collar, wherein the stabilizer recesses facilitate positioning of the collar for crimping.

45. The device of claim 43, wherein at least one of the folding arms, when inserted at least partially into one of the folding pockets, forms at least one indentation in the collar.

46. The device of claim 43, the second jaw portion comprising an alignment portion adjacent one of the stabilizer recesses, wherein the alignment portion facilitates the positioning of the collar such that the flat surface of the pressing portion contacts the collar at a predetermined distance from an edge of the collar.

47. The device of claim 46, the alignment portion comprising an abutment surface, the abutment surface facilitating the positioning of the collar when an edge of the collar is positioned in contact with the abutment surface.

48. A system for crimping a tube having a collar positioned thereon, the system comprising:
a tube;
a collar, for positioning over the tube, the collar having a circumferential recess defined therein;
a crimping tool, the tool comprising;
a first handle and a second handle, the first and second handles being connected about a hinge portion;
a first jaw holder, coupled to the first handle, and a second jaw holder coupled to the second handle;
a first jaw portion, coupled to the first jaw holder, the first jaw portion comprising two folding arms extending outwardly therefrom, and a and a pressing piece extending outwardly therefrom, the pressing piece comprising a substantially flat surface, the folding arms each having a pressing surface; and
a second jaw portion, coupled to the second jaw holder, the second jaw portion comprising a support surface, and two folding pockets, each folding pocket being designed and dimensioned to receive a respective one of the two folding arms;
wherein, when the first jaw portion and the second jaw portion are moved together, the flat surface of the pressing piece contacts the collar and compresses the collar against the support surface, causing the collar to separate at the circumferential recess.

49. A sampling system for sampling a liquid in a sterile environment, the system comprising:
one or more process vessels for distributing the liquid;
one or more tubes connected to the process vessels, for sampling the liquid;
a collar, for positioning over the tube, the collar having a circumferential recess defined therein;
a crimping tool, the tool comprising;
a first handle and a second handle, the first and second handles being connected about a hinge portion;
a first jaw holder, coupled to the first handle, and a second jaw holder coupled to the second handle;
a first jaw portion, coupled to the first jaw holder, the first jaw portion comprising two folding arms extending outwardly therefrom, and a and a pressing piece extending outwardly therefrom, the pressing piece comprising a substantially flat surface, the folding arms each having a pressing surface; and
a second jaw portion, coupled to the second jaw holder, the second jaw portion comprising a support surface, and two folding pockets, each folding pocket being designed and dimensioned to receive a respective one of the two folding arms;
wherein, when the first jaw portion and the second jaw portion are moved together, the flat surface of the pressing piece contacts the collar and compresses the collar against the support surface, causing the collar to separate at the circumferential recess, so that the collar and tube can be separated by hand and a sample can be obtained.

50. A method for crimping a tube, the method comprising the steps of:
providing a tube;
providing a collar having a circumferential recess defined therein;
positioning the collar over the tube;
providing a crimping tool, the tool comprising;
a first handle and a second handle, the first and second handles being connected about a hinge portion;
a first jaw holder, coupled to the first handle, and a second jaw holder coupled to the second handle;
a first jaw portion, coupled to the first jaw holder, the first jaw portion comprising two folding arms extending outwardly therefrom, and a and a pressing piece extending outwardly therefrom, the pressing piece comprising a substantially flat surface, the folding arms each having a pressing surface;
a second jaw portion, coupled to the second jaw holder, the second jaw portion comprising a support surface, and two folding pockets, each folding pocket being designed and dimensioned to receive a respective one of the two folding arms; and
moving the first jaw portion and the second jaw portion together, such that the flat surface of the pressing piece contacts the collar and compresses the collar against the support surface, causing the collar to separate at the circumferential recess.

51. A device for crimping a tube having a collar positioned thereon, the device comprising:
a first jaw portion, comprising one or more first hemispheroidal protrusions and one or more second hemispheroidal protrusions extending outwardly therefrom, and a pressing piece extending outwardly therefrom, the pressing piece comprising a flat pressing surface, and being positioned between the first and second hemispheroidal protrusions; and
a second jaw portion, comprising a support surface, and first and second folding pockets;
wherein the first folding pocket is designed and dimensioned to compress the collar in conjunction with the first hemispheroidal protrusions, and the second folding pocket is designed and dimensioned to compress the collar in conjunction with the second hemispheroidal protrusions

52. A device for crimping a tube having a collar positioned thereon, the device comprising:
a first jaw portion, comprising one or more first hemispheroidal protrusions and one or more second hemispheroidal protrusions extending outwardly therefrom, and a pressing piece extending outwardly therefrom, the pressing piece comprising a flat pressing surface, and being positioned between the first and second hemispheroidal protrusions; and
a second jaw portion, comprising a support surface, and one or more third hemispheroidal protrusions and one or more fourth hemispheroidal protrusions extending outwardly therefrom;
wherein the third hemispheroidal protrusions are designed and dimensioned to compress the collar in conjunction with the first hemispheroidal protrusions, and the fourth hemispheroidal protrusions are designed and dimensioned to compress the collar in conjunction with the second hemispheroidal protrusions.

53. The device of claim 52, wherein the hemispheroidal protrusions on the first jaw portion consist of one first hemispheroidal protrusion and one second hemispheroidal protrusion, and the hemispheroidal protrusions on the second jaw portion consist of two third hemispheroidal protrusions and two third hemispheroidal protrusions.

54. The device of claim 52, wherein the hemispheroidal protrusions on the first jaw portion consist of two first hemispheroidal protrusions and two second hemispheroidal protrusions, and the hemispheroidal protrusions on the second jaw portion consist of one third hemispheroidal protrusion and one third hemispheroidal protrusion.

55. The device of claim 52, wherein the pressing piece and support surface are configured such that the tube and collar are compressed when the first jaw portion and the second jaw portion are moved together.

56. The device of claim 52, wherein, when the first jaw portion and the second jaw portion are moved together, the pressing piece contacts the collar and compresses the collar against the support surface.

57. The device of claim 52, the second jaw portion comprising an alignment portion adjacent one of the third and fourth hemispheroidal protrusions, wherein the alignment portion facilitates the positioning of the collar such that the pressing portion contacts the collar at a predetermined distance from an edge of the collar.

58. The device of claim 57, the alignment portion comprising an abutment surface, the abutment surface facilitating the positioning of the collar when an edge of the collar is positioned in contact with the abutment surface.

59. A system for crimping a tube having a collar positioned thereon, the system comprising:
a tube;
a collar, for positioning over the tube;
a crimping tool, the tool comprising;
a first handle and a second handle, the first and second handles being connected about a hinge portion;
a first jaw holder, coupled to the first handle, and a second jaw holder coupled to the second handle;
a first jaw portion, coupled to the first jaw holder, the first jaw portion comprising one or more first hemispheroidal protrusions and one or more second hemispheroidal protrusions extending outwardly therefrom, and a pressing piece extending outwardly therefrom, the pressing piece comprising a flat pressing surface, and being positioned between the first and second hemispheroidal protrusions; and
a second jaw portion, coupled to the second jaw holder, the second jaw portion comprising a support surface, and comprising a support surface, and one or more third hemispheroidal protrusions and one or more fourth hemispheroidal protrusions extending outwardly therefrom.

60. A method for crimping a tube having a collar positioned thereon, the method comprising:
positioning the tube having a collar positioned thereon between a first jaw portion, coupled to the first jaw holder, the first jaw portion comprising one or more first hemispheroidal protrusions and one or more second hemispheroidal protrusions extending outwardly therefrom, and a pressing piece extending outwardly therefrom, the pressing piece comprising a substantially flat surface, and being positioned between the first and second hemispheroidal protrusions; and a second jaw portion, coupled to the second jaw holder, the second jaw portion comprising a support surface, and comprising a support surface, and one or more third hemispheroidal protrusions and one or more fourth hemispheroidal protrusions extending outwardly therefrom; and
moving the first jaw portion toward the second jaw portion such that at least one of the first and second hemispheroidal protrusions, when moved toward one of the third and fourth hemispheroidal pockets, crimps the tube and the collar.

61. The method of claim 60, comprising compressing the collar against the support surface with the pressing piece.

62. The method of claim 60, comprising positioning the collar in contact with an alignment portion such that the pressing piece contacts the collar at a predetermined distance from an edge of the collar.

63. The method of claim 60, comprising positioning an edge of the collar in contact with an abutment surface of the alignment portion.
